(19) United States
(12) Patent Application Publication
(10) Pub. No.: US 2024/0116710 A1
(43) Pub. Date: Apr. 11, 2024

(54) ARTIFICIAL INTELLIGENCE SYSTEM TO IDENTIFY ACTIVITY IN A RECEPTICAL

(71) Applicant: Microchip Technology Incorporated, Chandler, AZ (US)

(72) Inventors: Emmanuel Villand, Boulazac Isle Masnoir (FR); Jeremy Plantier, Pourrieres (FR)

(73) Assignee: Microchip Technology Incorporated, Chandler, AZ (US)

(21) Appl. No.: 18/095,777

(22) Filed: Jan. 11, 2023

Related U.S. Application Data
(60) Provisional application No. 63/415,012, filed on Oct. 11, 2022.

(51) Int. Cl. B65G 1/137

(52) U.S. Cl. CPC B65G 1/137; B65G 2203/0208

(57) ABSTRACT

A device comprising: a repository for an item, the repository having an item intake; a sensor that generates a signal corresponding to characteristics of an item in the repository; an artificial intelligence circuit that receives from the sensor the signal corresponding to characteristics of an item in the repository and that transmits an indicator signal indicative of the item in the repository; and an indicator that receives from the artificial intelligence circuit the indicator signal and that indicates the item in the repository based on the indicator signal.

### RELATED APPLICATION

This application claims priority to commonly owned U.S. Provisional Patent Application No. 63/415,012 filed Oct. 11, 2022, the entire contents of which are hereby incorporated by reference for all purposes.

### TECHNICAL FIELD

The present disclosure relates to a repository item identification systems and methods, and postal and package delivery systems and methods, in particular, systems and methods using artificial intelligence to identify items in repositories from item characteristic information.

### BACKGROUND

Mailboxes and lockboxes are typically used to receive mail and parcels through a postal or delivery system. A mail courier may manually raise a flag on the side of the mailbox to indicate mail has been placed in the box. However, such mailboxes and lockboxes do not indicate the contents of deposited therein.

There is a need for a repository that intelligently identifies items in a repository and indicates the contents of the repository to a user.

### SUMMARY

According to one aspect, there is provided a device comprising: a repository having an intake; an identification system having a sensor that generates a characteristic signal corresponding to a characteristic of an item in the repository; and an artificial intelligence circuit that receives from the sensor the characteristic signal, analyzes the characteristic signal to identify an item in the repository, and transmits an indicator signal indicative of the item in the repository.

An aspect provides a system comprising: a repository system having: a repository having an intake, and an identification system having at least one sensor that generates an characteristic signal corresponding to a characteristics of an item in the repository; a repository controller that configures the repository system; an artificial intelligence circuit that receives from the sensor the characteristic signal, analyzes the characteristic signal to identify an item in the repository, and transmits an indicator signal indicative of the item in the repository; an indicator circuit that receives from the artificial intelligence circuit the indicator signal and activates a notification of the presence of the item in the repository; a user computing device that transmits a configuration file to the repository controller and produces the notification of the presence of the item in the repository.

According to another aspect, there is provided a method comprising: pairing a user computing device and a repository controller; entering a configuration mode by the repository controller; receiving configuration information at the user computing device; generating a configuration file by the user computing device; transmitting the configuration file from the user computing device to the repository controller; configuring the repository controller to use communication protocols and radio frequency characteristics defined in the configuration file; entering a learning mode by a repository system; transmitting a first control message from the repository controller to the repository system, wherein the first control message comprises communication protocols and radio frequency characteristics; learning by the repository system from the first control message to use the communication protocols and radio frequency characteristics to communicate with the repository controller; transmitting a second control message from the repository controller to the repository system, wherein the second control message comprises configuration instructions; and artificially learning item characteristics with the repository system.

### BRIEF DESCRIPTION OF THE FIGURES

The figures illustrate a repository for items that uses sensors to generate characteristic signals corresponding to characteristics of items in the repository and an artificial intelligence circuit transmits an indicator signal indicative of the items in the repository based on the characteristic signals, and an indicator of the items in the repository.

FIG. 1 is a perspective view of a repository having an envelope intake, a package intake, sensors, an artificial intelligence circuit, a repository controller, and an indicator.

FIG. 2 shows a block diagram of a system having a repository system, a repository controller, a user computing device, and a communication network.

FIG. 3 shows a configuration file to be communicated between a user computing device and a repository controller.

FIG. 4 shows a flow chart of configuration messages transmitted between a user computing device, a repository controller, and a repository system

FIG. 5 shows a block diagram of an artificial intelligence circuit having inputs from repository sensors and an output to an indicator.

FIG. 6 shows a perspective system diagram of a repository, a user depositing a parcel in the repository, and a user computing device communicating with the repository via a communication network.

FIG. 7 shows a diagram of a repository having an intake, an identification system, and an artificial intelligence circuit.

The reference number for any illustrated element that appears in multiple different figures has the same meaning across the multiple figures, and the mention or discussion herein of any illustrated element in the context of any particular figure also applies to each other figure, if any, in which that same illustrated element is shown.

### DETAILED DESCRIPTION

The present disclosure provides a repository for any type of article that has the ability to identify, classify, or otherwise distinguish the deposited items and produce a notification signal of the deposited items. In one non-limiting example, the repository may be a mailbox for mail or packages.

In this detailed description, reference is made to the accompanying drawings, which form a part hereof, and in which are shown, by way of illustration, specific examples in which the present disclosure may be practiced. These examples are described in sufficient detail to enable a person of ordinary skill in the art to practice the present disclosure. However, other examples may be utilized, and structural, material; and process changes may be made without departing from the scope of the disclosure.

The illustrations presented herein are not meant to be actual views of any particular method, system, device; or structure, but are merely idealized representations that are employed to describe the examples of the present disclosure. The drawings presented herein may not be drawn to scale. Similar structures or components in the various drawings may retain the same or similar numbering for the convenience of the reader; however, the similarity in numbering does not mean that the structures or components may be identical in size, composition, configuration or any other property.

This description may include examples to help enable one of ordinary skill in the art to practice the disclosed examples. The use of the terms “by example,” and for example, means that the related description is explanatory, and though the scope of the disclosure is intended to encompass the examples and legal equivalents, the use of such terms is not intended to limit the scope of an example or this disclosure to the specified components, steps, features, functions, or the like.

The components of the examples as generally described herein and illustrated in the drawings could be arranged and designed in a wide variety of different configurations. Thus, this description of various examples is not intended to limit the scope of the present disclosure; but is merely representative of various examples. While the various aspects of the examples may be presented in drawings, the drawings may not be drawn to scale unless specifically indicated.

Furthermore, specific implementations shown and described are examples and may not be construed a single way to implement the present disclosure unless specified otherwise herein. Elements, circuits, and functions may be shown in block diagram form in order not to obscure the present disclosure. Conversely, specific implementations shown and described are examples and may not be construed as a single way to implement the present disclosure unless specified otherwise herein. Additionally, block definitions and partitioning of logic between various blocks is an example of a specific implementation. It will be readily apparent to one of ordinary skill in the art that the present disclosure may be practiced by numerous other partitioning solutions. For the most part, details concerning timing considerations and the like have been omitted where such details do not inform a complete understanding of the present disclosure and are within the abil id es of persons of ordinary skill in the relevant art.

Those of ordinary skill in the art would understand that information and signals may be represented using any of a variety of different technologies and techniques. For example, data, instructions, commands, information, signals, bits, and symbols that may be referenced throughout this description may be represented by voltages, currents, electromagnetic waves, magnetic fields or particles, optical fields or particles, or any combination thereof. Some drawings may illustrate signals as a single signal for clarity of presentation and description. It will be understood by a person of ordinary skill in the art that the signal may represent a bus of signals, wherein the bus may have a variety of bit widths and the present disclosure may be implemented on any number of data signals including a single data signal.

The various illustrative logical blocks modules and circuits described in connection with the examples disclosed herein may be implemented or performed with a general purpose processor, a special purpose processor, a Digital Signal Processor (DSP), air Integrated Circuit (IC), an Application Specific integrated Circuit (ASIC), a Field Programmable Gate Array (FPGA) or other programmable logic device, discrete gate or transistor logic, discrete hardware components, or any combination thereof designed to perform the functions described herein. A general-purpose processor (may also be referred to herein as a host processor or simply a host) may be a microprocessor, but in the alternative, the processor may be any conventional processor, controller, microcontroller, or state machine. A processor may also be implemented as a combination of computing devices, such as a combination of a DSP and a microprocessor, a plurality of microprocessors, one or more microprocessors in conjunction with a. DSP core, or any other such configuration. A general-purpose computer including a processor is considered a special-purpose comp u ter while the general-purpose computer is configured to execute computing instructions (e.g., software code) related to examples of the present disclosure.

The examples may be described in terms of a process that is depicted as a flowchart, a flow diagram, a structure diagram, or a block diagram. Although a flowchart may describe operational acts as a sequential process, many of these acts can be performed in another sequence, in parallel, or substantially concurrently. In addition, the order of the acts may be re-arranged. A process may correspond to a method, a thread, a function, a procedure, a subroutine, or a subprogram, without limitation. Furthermore, the methods disclosed herein may be implemented in hardware, software, or both if implemented in software, the functions may be stored or transmitted as one or more instructions or code on computer-readable media. Computer-readable media includes both computer storage media and communication media including any medium that facilitates transfer of a computer program from one place to another.

Any reference to an element herein using a designation such as “first,” “second,” and so forth does not limit the quantity or order of those elements, unless such limitation is explicitly stated. Rather, these designations may be used herein as a convenient method of distinguishing between two or more elements or instances of an element. Thus, a reference to first and second elements does not mean that no more than two elements may be employed there or that the first element must precede the second element in some manner. In addition, unless stated otherwise, a set of elements may comprise one or more elements.

As used herein, the term “substantially” in reference to a given parameter, property, or condition means and includes to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

As used herein, “configurable” means configurable and re-configurable.

A repository system (RS) may be configured for a specific communication protocol, and tuned to specific; radio frequency (RE) characteristics according to an electronic key. So, an electronic key may be used to transmit messages to an RS according to the communication protocol of the RS, and the electronic key wirelessly transmits the messages on a carrier exhibiting the RF characteristics of the RS. An RS that uses a specific communication protocol and that is tuned to specific RF characteristics of carrier signals may not respond to messages from an electronic key that sends messages using a different communication protocol or different RF characteristics. So, unless an electronic key sends messages to an RS using a communication protocol and RF characteristics of the RS, the RS will not learn an identifier of the electronic key (in the case of initial setup of an electronic key to work with the RS), nor will the RS respond to control messages (e.g., lock, unlock, open door, without limitation) sent by a known electronic key.

One or more examples relate, generally, to a repository controller that is to interface with a system, and systems for configuring or operating the repository controller such that, as a non-limiting example, an authorized party may access a repository, i.e., vehicle, building, container, facility, room, or other repository resource (all referred to herein as a “repository” for ease of description, but without limitation), where access to a repository is controlled by the repository controller.

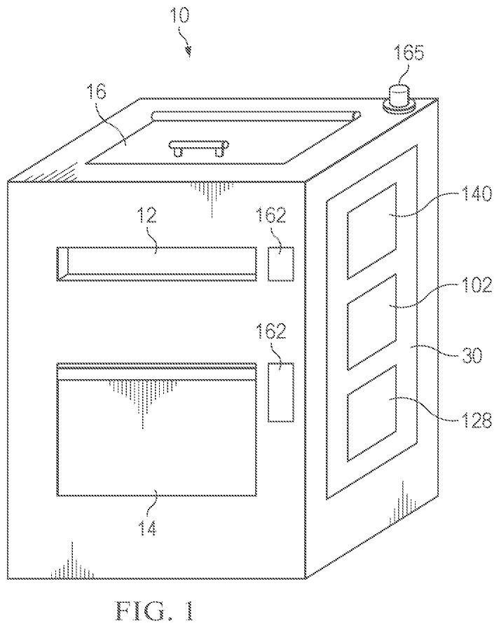

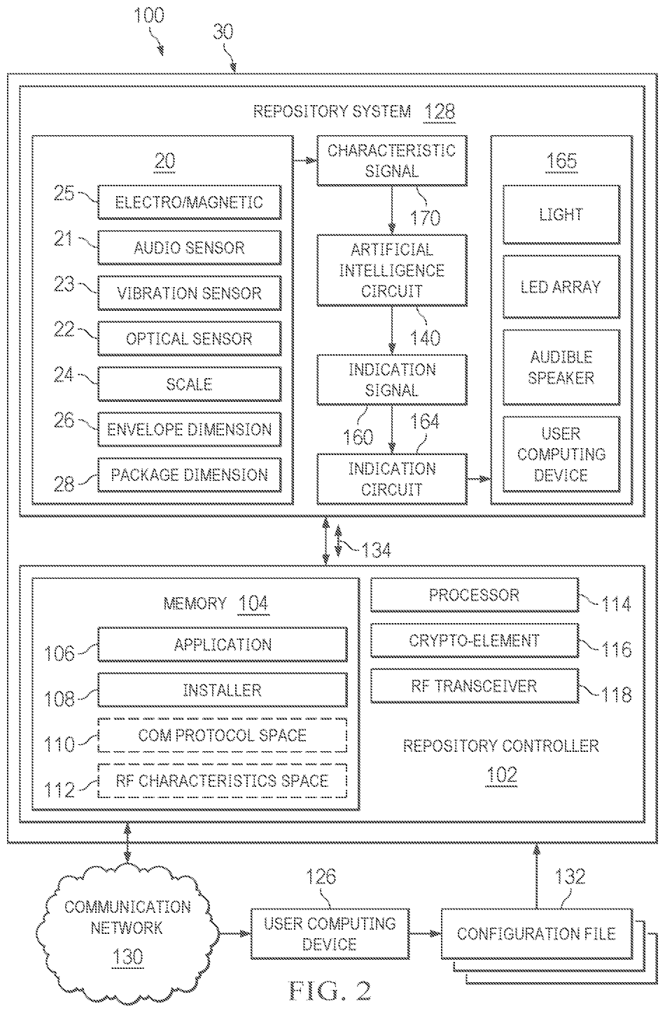

FIG. 1 shows a perspective view of a repository 10. The repository 10 may be a box-like structure having an envelope intake 12 and a package intake 14 through which items may be deposited in the repository 10. The envelope intake 12 may have a geometric size and shape to allow a standard postal envelope to pass through the envelope intake 12. The term “standard postal envelope” includes any size and weight envelope used in a postal system, wherein examples include but are not limited to: #9 (3⅞″×8⅞″); #10 (4⅛″×9½″); A1 (3⅝″×5⅛″); A4 (4¼″×6¼″); DL (110×220 mm); E4 (220×312 mm); E5 (115×220 mm); and S4 (250×330 mm). The package intake may have a geometric size and shape to allow a standard postal package to pass through the package intake 14. The term “standard postal package” includes any size and weight package used in a postal system, wherein examples include but are not limited to: flat padded envelope (11⅝″×15″); flat padded envelope (9½ ″×12½″); small box (5 7/16″×1¾ ″×8 11/16″); medium box (12″×3½ ″×14⅛″); and large box (6″×12″×12′¼″). Respective sensors 162 are associated with the envelope intake 12 and the package intake 14. An access door 16 in the top, side, or bottom, of the repository 10 provides access through which deposited items may be removed from the repository 10. The repository 10 also has a repository control system 30 that includes a repository controller 102, a repository system 128, an artificial intelligence system 140, and an indicator circuit 164 (described in relation to FIG. 2, below). The repository control system 30 identifies items deposited in the repository and provides an indication to the user as to the contents of the repository 10 via an indicator 165.

FIG. 2 shows a block diagram of an example of a system 100 for configuring repository controller 102 with a control message from a user computing device 126 to operate repository system 128 in the example shown in FIG. 2, repository controller 102 has not yet been configured to communicate with repository system 128, and repository system 128 has not yet learned the specific communication protocol and radio frequency (RF) characteristics according to an electronic key to communication with the repository controller 102. The repository controller 102 enables an artificial intelligence circuit 140 to learn to identify specific categories of items deposited in the repository 10. For example, the artificial intelligence circuit 140 may recognize a different envelope with dimensional and weight characteristics via the characteristic signals 170 (see FIG. 2) related to previously deposited envelopes and packages and add it to its knowledge base to expand the knowledge base related to, for example, package type recognition and shipper identification in an organized and structured way.

Repository control system 30 may include an identification system 20 and at least one processor 114 communicatively connected to the identification system 20. The identification system 20 may include a weighing device or scale 24, a size measuring device (e.g. envelope dimension sensor 26 and package dimension sensor 28), a vibration sensor 23, an optical sensor 22, an audio sensor 21, an electro/magnetic sensor 25, or a combination thereof. Optical sensor 22 may include, for example, a camera, an optical detector, a radar sensor, a laser sensor, LED, photoelectric cell, or an infrared sensor, without limitation. Any type of sensor may also be included in the identification system 20 including a radio frequency identification (RFID) sensor. The processor 114 may feature a decoding application for reading a code detected by the optical sensor 22, for example the code may be a quick response (QR) code or other bar code. The processor 114 may also feature a package recognition application for determining a type for the package using data obtained from the weighing device 24, the size measuring device (e.g. envelope dimension sensor 26 and package dimension sensor 28), the vibration sensor 23, the optical sensor 22, or a combination thereof. The processor 114 may further include a courier recognition application for determining an identity of a shipper for the package using data obtained from the weighing device or scale 24, the measuring device (envelope dimension sensor 26 and package dimension sensor 28), the vibration sensor 23, the optical sensor 22, or a combination thereof. Package criteria may be selected from: a weight, mass, height, width, length or depth, a shipper, and a type. The type of the package may be a box, a letter-sized envelope, an envelope larger than letter-sized, a tube, a post card, or another type of shipping package.

The repository 10 may have an envelope intake 12 for receiving envelopes, letters, and cards, and the repository system 128 may have an associated sensor 162 to detect such an item as it passes through the envelope intake 12. The envelope intake 12 may have the associated sensor 162 to identify an envelope characteristic selected from: a weight, mass, height, width, length or depth, a shipper, and a type. The associated sensor 162 may be an instance of weighing device or scale 24, a size measuring device such as an instance of envelope dimension sensor 26, an instance of vibration sensor 23, an instance of optical sensor 22, or a combination thereof. The associated sensor 162 may be an optical detector, a radar sensor, a laser sensor, an infrared sensor, an audio sensor, or a radio frequency identification (RFID) sensor, or a combination thereof.

The repository 10 may have a package intake 14 for receiving packages, and the repository system 128 may have an associated sensor 162 to detect such an item as it passes through the package intake 14. The package intake 14 may have the associated sensor 162 to identify a package characteristic selected from: a weight, mass, height, width, length or depth, a shipper, and a type. The associated sensor 162 may be an instance of weighing device or scale 24, an instance of a size measuring device such as an instance of envelope dimension sensor 26, an instance of vibration sensor 23, an instance of optical sensor 22, or a combination thereof. The associated sensor 162 may be an optical detector, a radar sensor, a laser sensor, an infrared sensor, an audio sensor, or a radio frequency identification (RFID) sensor, or a combination thereof.

Weighing device or scale 24 may determine, or aid in determining, a weight or mass of an item, size measuring device (e.g. envelope dimension sensor 26 and package dimension sensor 28) may determine, or aid in determining, linear dimensions of an item, and optical sensor 22, which may comprise multiple optical sensors 22, may detect a code displayed on the item or elsewhere. The repository 10 may have a repository control system 30 to differentiate between different types of items deposited in the repository 10, for example, between letters, cards, envelopes, packages, bags, newspaper, mailers, junk mail, tubes, or other item. As shown in FIG. 2, an indicator circuit 164 may drive indicator 165 to provide a visual indication to the user as to the deposited items. The indicator 165, responsive to indicator circuit 164, may be colored lights wherein different colors correspond to different categories of deposited items. See FIG. 1. The indicator 165 may further be an LED array that provides a text description of different categories of deposited items. Indicator circuit 164 may be used to provide a visual or audible indication to the user, where indicator 165 may be implemented as an audible speaker. The indicator 165 may be an alarm or alert displayed or provided by a user computing device 126, for example, a smart phone that provides a notification in the form of a vibration, tone, or display notification. See FIG. 2. The identification system 20 sends a characteristic signal 170 to the artificial intelligence circuit 140. The artificial intelligence circuit 140 uses the information from the characteristic signal 170 and may use other information to generate an indicator signal 160, which it sends to the indicator circuit 164. The indicator circuit 164 activates a notification of the presence of the item in the repository by activating an indicator 165, for example, a light, an LED array, an audible speaker, or a user computing device 126. In one example, a user computing device produces the notification. Referring to FIG. 2; user computing device 126 may enable a user to configure repository controller 102 such that repository controller 102 may communicate with repository system 128. As non-limiting examples, a user may be a person, a controller, an automated software process; an artificial intelligence (AI) process, and combinations thereof. As a non-limiting example, user computing device 126 may be a general purpose computing device programmed or configured to perform various functions of disclosed examples of user computing device 126, such as a smartphone, tablet computer, laptop computer, desktop computer, or a wearable device, without limitation.

As shown in FIG. 2, user computing device 126 and repository controller 102 may communicate with each other via a communication network 130. User computing device 126 and repository controller 102 may communicate using any of a number of wireless communication protocols, including Bluetooth, Near Field Communication, cellular communication, and WiFi, or any one of a number of wired communication protocols such as one or more versions and form factors of Universal Serial Bus (USB), FireWire, optical data transfer, Ethernet, and High Definition Multimedia Interface, without limitation.

User computing device 126 may provide a prompt (e.g., a graphical user interface (GUT) provided at a display of user computing device 126, the GUI including one or more GUI elements for providing instructions and for entering information (e.g., fields, menus, without limitation)) to a user to enter information that may be used to configure repository system 128 by sending a configuration file 132 to the repository controller 102, which then configures repository system 128 via instructions 134. In a repository system scenario, the entered information in addition to the make or model information of an instance of repository, 10 may be used to generate a configuration file 132. User computing device 126 may forward the configuration file 132 to repository controller 102.

In various examples, a user may also enter customer profile information at user computing device 126. The customer profile information and associated repository configuration preferences may be used to create a configuration file 132.

In one example, respective repository system configuration files 132 may include RF characteristics and communication (COM) protocols associated with repository systems used with various makes, models, and years of repositories, and customer accounts may store the make, model and year of a repository associated with a specific customer account.

Repository controller 102 may include a memory 104, processor 114, crypto-element 116, and RE transceiver(s) 118. Memory 104 may store various modules, including one or more of application 106, installer 108, as well as communication modules. As illustrated in FIG. 2, a communication module may be installed at repository controller 102, and space in memory may be reserved as COM protocol space 110. Space is also reserved to store RE characteristics in an RF characteristics space 112. Two code spaces are shown in FIG. 2 merely to highlight functional independence, but notably, COM protocol space 110 and characteristics space 112 may be located on the same memory device at predetermined locations, located on different memory devices, or located on the same memory device on overlapping or interleaved locations, without limitation.

As non-limiting examples, memory 104 may be or include one or more of a Flash memory electrically erasable programmable read-only memory electrically erasable programmable read-only memory (EEPROM), and read-only memory (ROM), random access memory (RAM), without limitation. In one example, application. 106 and COM protocol space 110 may be stored on a Flash memory or RAM, RIF Characteristics space 112 may be stored on an EEPROM, and installer 108 may be stored on a ROM.

As non-limiting examples, RF characteristics stored at RF characteristics space 112 may include one or more of frequency, modulation type (e.g., amplitude-shift key modulation or frequency-shift keying modulation, without limitation), data rate, and output power. As non-limiting examples, communication protocol instructions stored at COM protocol space 110, may include rules for formatting messages sent to repository system 128. Rules for formatting messages, as non-limiting examples, may include rules for contents of data packets that comprise a message. Contents may include identifiers, command codes such as command codes for identifying certain envelopes, identifying certain packages, opening the access door 16, and error correction (e.g., checksum, cyclic redundancy check, without limitation).

In FIG. 2, COM protocol space 110 and RF characteristics space 112 are depicted having a border including a dashed line. In an example, the dashed lines indicate that no instructions or parameters are presently stored. In another example, the dashed lines indicate that instructions or parameters stored at COM protocol space 110 and RF characteristics space 112 will be replaced.

Installer 108 may, generally, enable repository controller 102 (and processor 114 executing installer 1108 more specifically) to receive configuration file 132 including COM protocols and RF characteristics, and to store such RF characteristics and COM protocols at COM protocol space 110 and RF characteristics space 112, respectively.

Application 106 may, generally, enable repository controller 102 (and processor 114 executing application 106 more specifically) to send messages to repository system 128, such as control message 134 (e.g., configuration instructions the repository system 128 may use for identifying certain envelopes, identifying certain packages, opening the access door 16, or closing the access door 16 without limitation) using COM protocols and RE characteristics (once installed) stored at memory 104. Repository controller 102 may access and use COM protocols and RF characteristics stored at COM protocol space 110 and RE characteristics space 112, respectively, to format messages and configure RE signals that carry the messages.

Crypto-element 116 may, generally, perform an authentication process with user computing device 126, as a non-limiting example, a challenge-response process that uses public or private keys. Crypto-element 116 may comprise one or more memories for storing, a unique identifier associated with repository controller 102, and crypto-element 116 may provide such an identifier to processes at repository controller 102 such as processes for pairing repository controller 1102 with repository system 128, or sending instructions to repository system 128 to identify certain envelopes, identify certain packages, open the access door 16, or close the access door 16, without limitation.

RF transceiver(s) 118 may, generally, send signals that exhibit the RF characteristics stored at RF characteristics space 112 and that carry messages sent using COM protocols stored at COM protocol space 110. Repository system 128 may use a specific COM protocol and be tuned to specific RF characteristics of carrier signals, and will not respond to messages that do not comply with the COM protocol or RF characteristics.

Repository controller 102 may send control message 134 to repository system 128, including while repository system 128 is in a learn mode of operation (i.e., an operational mode during which repository system 128 may add items to its list of known items). In one example, control message 134 may include a coded message that includes an identifier associated with (i.e., uniquely identifying) repository controller 102 or commands (e.g., control protocols to enable identification of certain envelopes or packages, and to open or close the access door 16).

In one or more examples, repository system 128 may be placed in a learning mode of operation by a user, as a non-limiting example, by activating a button or switch. While in a learning mode of operation, repository system 128 may store an envelope or package identifier sent in a control message (e.g., control message 134) that is a properly formatted or encoded message (i.e., using COM protocols stored at COM protocol space 110) at a list of approved envelope or package identifiers.

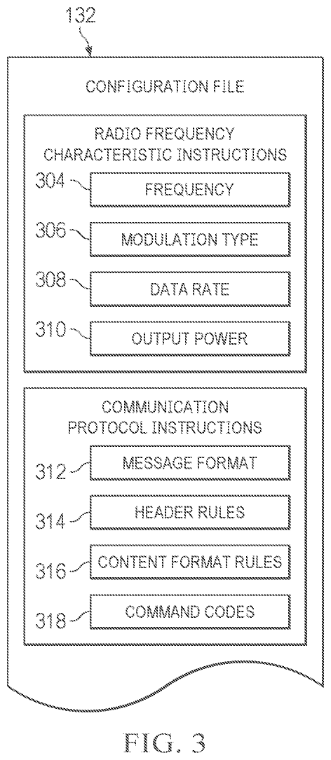

FIG. 3 shows a diagram of an example configuration file 132 (i.e., an electronic file readable by a computer) usable to configure a repository controller 102, of FIG. 2. Configuration file 132 includes fields for instructions for radio frequency characteristics and instructions for communication protocols. Fields for radio frequency characteristics include a field for frequency 304 a field for modulation type 306, a field for data rate 308, and a field for output power 3110. Modulation types may be one or more of: amplitude-shift key modulation or frequency-shift keying modulation, without limitation. Fields for communication protocol instructions include a field for message format 312 (e.g., description of fields that may be included in a message, without limitation), a field for header rules 314 (e rules for information for formatting information in a header, such as an identifier, without limitation), a field for content format rules 316 (e.g., rules for formatting content of various fields in a message defined in message format 312, such as command codes 318, without limitation, or rules for contents of data packets that comprise a message), and a field for command codes 318 (e.g., codes used to represent commands such as lock, unlock, open, dose, without limitation). During a setup operation, an installer (e.g., installer 108, without limitation) may parse configuration file 132, read one or more contents of the fields of configuration file 132, and store the contents at configurable repository controller 102, (e.g., at COM protocol space 110 or RF characteristics space 112 of repository, controller 102, without limitation).

Various networks may be implemented in accordance with examples, such as communication network 130. Such networks may include wired paths, wireless paths, and a combination of wired to wireless paths. Such networks may include the Internet, an Extranet, an Ethernet, a Win network, or any other system that enables communication. Notably, a transceiver (e.g., RF transceiver 118) may be a device configured as transmitter, receiver, or both. Moreover, a transceiver may be one device to receive to transmit RE signals, or it may be multiple devices, for example, one device to receive RF signals and another device to transmit RF signals.

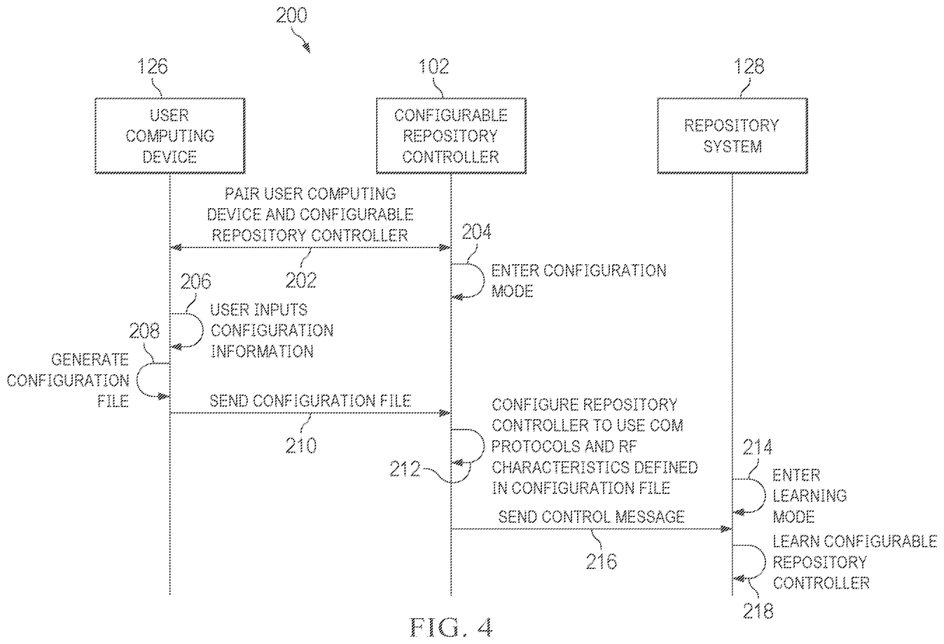

FIG. 4 illustrates a configuration/re-configuration process 200 performed by user computing device 126 repository controller 102, and repository system 128 of system 100, In operation 202, user computing device 1126 and repository controller 102 are paired, for example, by way of an authentication process that involves using public/private keys. In operation 204, repository controller 102 enters a configuration mode of operation in response to pairing with user computing device 126 in operation 202. In operation 206, a user identifies the desired repository system 128 and enters desired repository configuration information at user computing device 126 to create a configuration file 132. In one example, user computing device 126 may provide a prompt at a display thereof, the prompt including fields for entering text for repository configuration information. In operation 208, user computing device 126 generates a configuration file (e.g., configuration file 132 of FIG. 2 or FIG. 3) for the repository selected in operation 206. The configuration file may include instructions for a COM protocol and information about RF characteristics for communication with repository system 128 to be utilized by repository controller 102. In operation 210, user computing device 126 sends the configuration file to repository controller 102 for installation. In operation 212, repository controller 102 uses the COM protocol and RF characteristics in the configuration file received in operation 210. In operation 214 repository system 128 enters a learning mode of operation. In one example, repository system 128 may enter the learning mode of operation in response to performance of pre-specified interactions with repository system 128 such as envelopes or packages of a certain kind being deposited at certain times of day, or a command from user computing device 126 forwarded by repository controller 102. In operation 216, repository controller 102 sends a control message to repository system 128 according to the COM protocol and RF characteristics stored at repository controller 102, for example specific communication protocols and specific radio frequency (RF) characteristics according to an electronic key in operation 218, repository system 128 “learns” from repository controller 102 such that repository system 128 will respond to control messages including commands that are received from repository controller 102, for example according to an electronic key. Further, learning by repository system 128 may include setting/configuring repository system 128 to respond to control messages from repository controller 102, including control messages related to artificial intelligence. Thus, “learning” is the process by which the repository system 128 is set up or configured to receive control messages from the repository controller 102, to identify items in a repository, and to notify of items in a repository.

The repository control system 30 may automatically recognize the shape, size, weight, or another characteristic of a package and determine it to be a box, postcard, a letter, or a tube. The repository control system 30 may use open source computational vision processing for these identification functions. The repository control system 30 may use artificial intelligence software of an artificial intelligence circuit 140 to recognize a different envelope with dimensional and weight characteristics via the characteristic signals 170 (see FIG. 2) related to previously deposited envelopes and packages and add it to its knowledge base to expand the knowledge base related to, for example, package type recognition and shipper identification in an organized and structured way. Artificial intelligence (AI) methodologies also can implement, at least in part, functionality of the repository control system 30 and may be implemented in hardware or as a software or firmware application retained in memory as a set of code instructions and executed by one or more processors. At least one of analog processing or digital processing can implement, at least in part, functionality of repository control system 30.

In an aspect, repository system 128 can exploit artificial intelligence (AI) methods of the artificial intelligence circuit 140 to generate identification intelligence to expand a knowledge base related to; for example; package type recognition and shipper identification. Such intelligence can be generated through inference, e.g., reasoning and conclusion synthesis based upon a set of metrics arguments, or known outcomes in controlled scenarios, or training sets of data. Artificial intelligence methods or techniques referred to herein typically apply advanced mathematical algorithms e.g., decision trees, neural networks, regression analysis, principal component analysis (PCA) for feature and pattern extraction, cluster analysis, genetic algorithm, or reinforced learning to a data set. In particular, artificial intelligence circuit 140 can employ one of numerous methodologies for learning from data and then drawing inferences from the models so constructed from the characteristic signals 170 (see FIG. 2) related to previously deposited envelopes and packages.

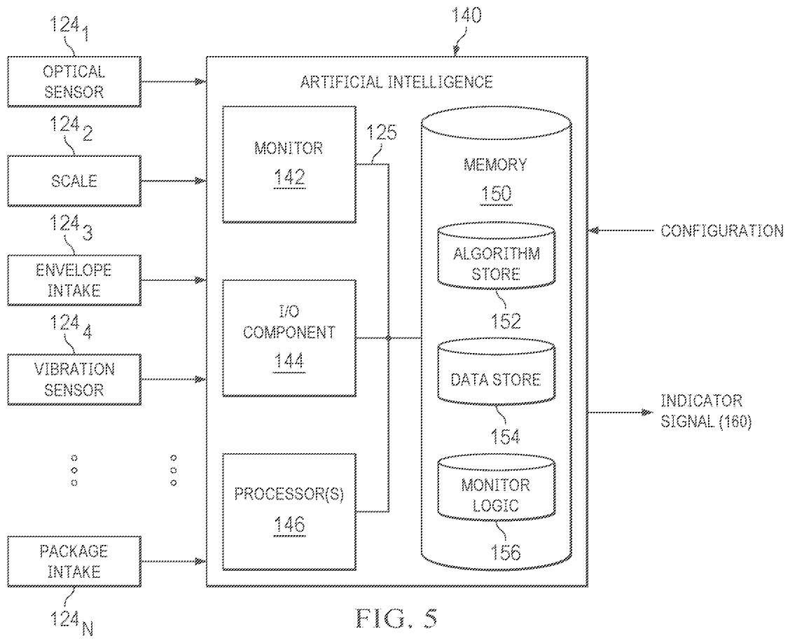

FIG. 5 is a block diagram of an example of an artificial intelligence circuit 140 for a repository, which can disclose a specific mode of generation and reporting of item identification intelligence. Artificial intelligence circuit 140 may identify one or more groups of one or more inputs 1241-124N to be monitored and a specific function to be applied to at least one of the identified groups. Artificial intelligence circuit 140 also can determine a period for which historical data on input signal is to be reported. Artificial intelligence circuit 140 includes an input/output (I/O) component 144 that can enable download of available item identification intelligence, which can be utilized for one or more of root cause analysis, recordation of historical operating status, or the like. Processor(s) 146 can be configured to provide or can provide, at least in part, the described functionality of artificial intelligence circuit 140 or components therein. In an aspect, to provide such functionality, processor (s) 146 can exploit bus 125 to exchange data or any other information amongst components within artificial intelligence circuit 140, including memory 150 or elements therein, such as or algorithm store 152, data store 154, or monitoring logic 156. Bus 125 can be embodied in at least one of a memory bus, a system bus, an address bus, a message bus, or any other conduit, protocol, or mechanism for data or information exchange among components that execute a process or are part of execution of a process. The exchanged information can include at least one of code instructions, code structure(s), data structures, or the like. Processor(s) 146 also can execute code instructions (not shown) stored in memory 150 to implement or provide at least part of the described functionality of artificial intelligence circuit 140. Such code instructions can include program modules or software or firmware applications that implement specific tasks which can be accomplished through one or more of the methods described herein and that are associated, at least in part, with functionality or operation of example repository 10. In one or more alternative or additional example(s), processor(s) 146 can be distributed amongst one or more components of artificial intelligence circuit 140. Further, in some examples, at least one of monitor 142 or I/O component 144 can reside within memory 150 as one or more sets of code instructions that, when executed by processor(s) 146, implement such components and described functionality thereof.

Artificial intelligence circuit 140 may be realized in a dedicated integrated circuit that is distinct from a core IC. Monitor 142 can monitor input signals 1241-124N from sensors 162 associated with optical sensor(s), weight or mass scales, an envelope intake, a package intake, vibration sensor, or another sensor or combination of sensors. Monitor logic 156 retained in memory 150 can include one or more rules to be applied to received input signal(s) 1241-124N; the one or more rules can dictate function(s) to be applied to input data and subsets thereof and associated results delivered in indicator signals 160 or the like. Monitor logic 156 retained in memory 150 also can include identification characteristics that define known item characteristics for various items anticipated to be deposited in repository 10; monitor 142 can compare input signals 1241-124N with predetermined characteristic ranges and establish if the characteristic corresponds to a known item; in an aspect, abnormal identification characteristic(s) can be reported to indicate an unidentifiable deposit. The artificial intelligence circuit 140 may receive a characteristic signal(s) 170 from a sensor of the identification system 20, analyze the characteristic signal(s) 170 to identify an item in the repository 10, and transmit an indicator signal 160, indicative of an item in the repository, to the indicator circuit 164. (See FIG. 2). The indicator circuit 164 may be configured to produce one or more specific indictors 165, such as a light, LED light, audible sound, or an indicator via the user computing device.

In addition, processor 146 can construct models based on information provided by the set of input signal(s) 1241-124N, which are components of the characteristic signals 170 (see FIG. 2) related to previously deposited envelopes and packages. Models can be based at least in part on historical input data, which can be retained in data store 154, and generated intelligence can be retained in data store 154. In an aspect, generation of intelligence can include various operations on collected data such as generation of patterns (temporal or spatial) of identification characteristics of one or more input signal(s) 1241-124N, e.g., patterns of characteristic(s) in the set of input signal(s) 1241-124N can be identified and correlated with repository information, e.g., item identification characteristics.

Such methodologies can be retained in algorithm store 152 to identify the letters, cards, envelopes, packages, bags, newspaper, mailers, junk mail, tubes, or other item deposited in repository 10. As an example, Hidden Markov Models (Ills) and related prototypical dependency models can be employed. General probabilistic graphical models, such as Dempster-Shafer networks and Bayesian networks like those created by structure search using a Bayesian model score or approximation can also be utilized. In addition, linear classifiers, such as support vector machines (SVMs), non-linear classifiers like methods referred to as “neural network” methodologies, or fuzzy logic methodologies can also be employed. Mon-over, game theoretic models (e.g., game trees, game matrices, pure and mixed strategies, utility algorithms, Nash equilibria, evolutionary game theory, or other model or combination of models) and other approaches that perform data fusion, may be exploited.

Referring to FIG. 5, artificial intelligence circuit 140 may disclose a specific mode of generation and reporting of identification intelligence, for example, identify one or more groups of one or more inputs 1241-124N to be monitored and a specific function to be applied to at least one of the identified groups. As another example, artificial intelligence circuit 140 also may determine a period for which historical data on input signal is to be reported. Artificial intelligence circuit 140 includes an input/output (I/O) component 144 that may enable download of available identification intelligence, which may be utilized for one or more of root cause analysis, recordation of historical operating status, or the like.

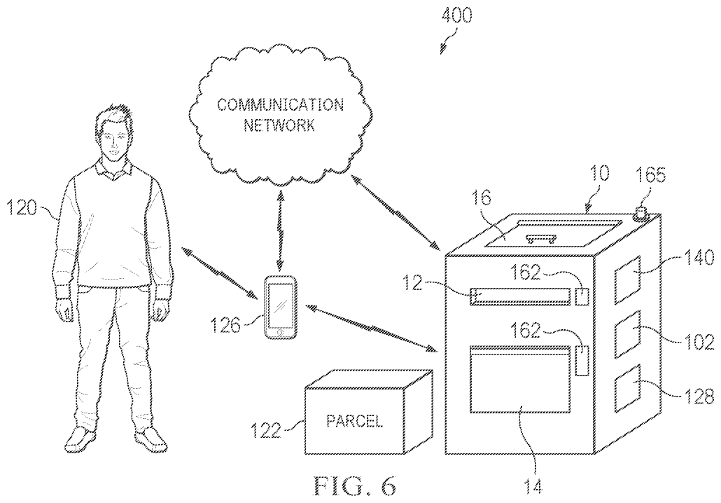

FIG. 6 shows a block diagram of a system 400 including a user computing device 126 and a repository 10 controlled by a repository system 128 and configured by a repository controller 102. In the example contemplated by FIG. 6, delivery person 120 intends to deposit parcel 122 in repository 10, and more specifically, through the package intake 14. However, the accesses to repository 10 (i.e., envelope intake 12, package intake 14, and access door 16) are locked, and under the control of repository system 128.

A delivery person 120 uses a user computing device 126 (e.g., a smartphone or custom device without limitation) as an interface to communicate with repository controller 102. A first communication link (here, a wireless communication link) has been established (as discussed herein) between user computing device 126 and repository controller 102, and user computing device 126 may send messages (e.g., requests to unlock, lock, and open, without limitation) to repository controller 102 via the first communication link. To unlock an intake or door of the repository 10, delivery person 120 may use user computing device 126 to send a message including an access request to repository controller 102 via the first communication link. Notably, repository controller 102 may be physically located anywhere (in the user computer device 126, in the communication network 130, or in the repository 10) as long as it is able to form a communication link with user computing device 126 and a communication link with repository system 128. As shown in FIG. 2, a second communication link (here, wired or wireless) is established between repository controller 102 and repository system 128. The second communication link may be hard-wired, so as to be dependably available, or established in response to establishment of the first communication link. Repository controller 102 may send, in response to the access request from user computing device 126 sent on the first communication link, a control message to repository system 128 via the second communication link in this scenario, the control message may include a package intake unlock/open command, in response to which repository system 128 unlocks or opens the package intake 14 of repository 10.

Referring to FIG. 6, upon depositing parcel 122 in the package intake 14 of repository 10, delivery person 120 may use user computing device 126 to send a message including a close or lock request to repository controller 102 via the first communication link in response to the lock request, repository controller 102 may send a control message including a close or lock command to repository system 128 via the second communication link. In response to the lock command, repository system 128 closes or locks the package intake 14 of repository 10.

Another example similar to the example shown in FIG. 6 provides a system wherein the user computing device 126 comprises the artificial intelligence circuit 140 rather than the repository system 128.

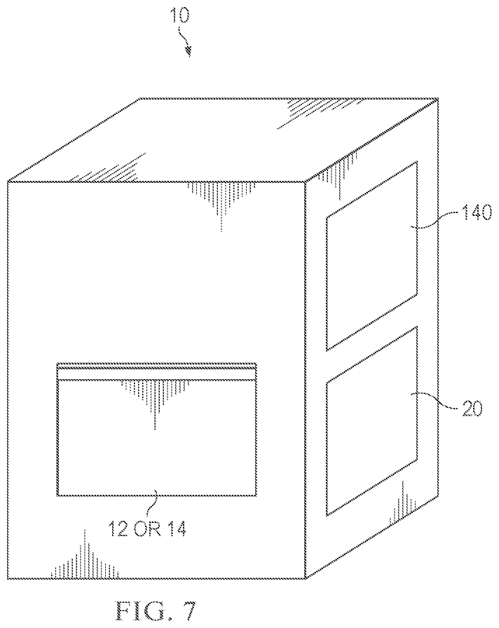

FIG. 7 shows a diagram of a repository 10 having an envelope intake 12 or a package intake 14, an identification system 20, and an artificial intelligence circuit 140.

While the present disclosure has been described herein with respect to certain illustrated examples, those of ordinary skill in the art it recognize and appreciate that the present invention is not so limited. Rather, many additions, deletions, and modifications to the illustrated and described examples may be made without departing from the scope of the invention as hereinafter claimed along with their legal equivalents. In addition, features from one example may be combined with features of another example while still being encompassed within the scope of the invention as contemplated by the inventor.

1. A device comprising:
a repository having an intake;
an identification system having a sensor that generates a characteristic signal corresponding to a characteristic of an item in the repository; and
an artificial intelligence circuit that receives from the sensor the characteristic signal, analyzes the characteristic signal to identify an item in the repository, and transmits an indicator signal indicative of an item in the repository.

2. The device as claimed in claim 1, comprising an indicator circuit that receives from the artificial intelligence circuit the indicator signal and that indicates the item in the repository based on the indicator signal.

3. The device as claimed in claim 1, wherein the intake of the repository comprises an intake selected from an envelope intake and a package intake, wherein the envelope intake has a geometric size and shape to allow a standard postal envelope to pass through the envelope intake, wherein the package intake has a geometric size and shape to allow a standard postal package to pass through the package intake.

4. The device as claimed in claim 1, wherein the sensor of the identification system comprises a sensor selected the group consisting of a: an audio sensor, an optical sensor, a vibration sensor, a scale, an electro/magnetic sensor.

5. The device as claimed in claim 1, wherein the artificial intelligence circuit comprises an intelligent driver, an input/output component, a processor, and a memory.

6. The device as claimed in claim 1, comprising an indicator selected the group consisting of a light, an LED array, an audible speaker, and a user computing device.

7. The device as claimed in claim 1, comprising a repository controller that configures the repository.

8. The device as claimed in claim 1, comprising an access door, wherein the access door is a separate door from the intake door.

9. A system comprising:
a repository system having:
a repository having an intake, and
an identification system having at least one sensor that generates a characteristic signal corresponding to a characteristic of an item in the repository;
a repository controller that configures the repository system;
an artificial intelligence circuit that receives from the sensor the characteristic signal, analyzes the characteristic signal to identify an item in the repository, and transmits an indicator signal indicative of the item in the repository;
an indicator circuit that receives from the artificial intelligence circuit the indicator signal and activates a notification of the presence of the item in the repository;
a user computing device that transmits a configuration file to the repository controller and produces the notification of the presence of the item in the repository.

10. The system as claimed in claim 9, wherein the sensor of the identification system comprises a sensor selected the group consisting of a camera, a vibration sensor, a scale, an optical detector, radar sensor, laser sensor, infrared sensor, audio sensor, and a radio frequency identification sensor.

11. The system as claimed in claim 9, wherein the artificial intelligence circuit comprises an intelligent driver, an input/output component, a processor, and a memory.

12. The system as claimed in claim 9, wherein the repository controller has a processor, a memory, and a RF transceiver.

13. The system as claimed in claim 9, wherein the artificial intelligence circuit is in the user computing device.

14. A method comprising:
pairing a user computing device and a repository controller;
entering a configuration mode by the repository controller;
receiving configuration information at the user computing device;
generating a configuration file by the user computing device;
transmitting the configuration file from the user computing device to the repository controller;
configuring the repository controller to use communication protocols and radio frequency characteristics defined in the configuration file;
entering a learning mode by a repository system;
transmitting a first control message from the repository controller to the repository system, wherein the first control message comprises communication protocols and radio frequency characteristics;
learning by the repository system from the first control message to use the communication protocols and radio frequency characteristics to communicate with the repository controller;
transmitting a second control message from the repository controller to the repository system, wherein the second control message comprises configuration instructions; and
artificially learning item characteristics with the repository system

15. A method as claimed in claim 14, wherein the second control message configures an identification system having a sensor that generates a characteristic signal corresponding to a characteristic of an item in a repository.

16. A method as claimed in claim 14, wherein the second control message configures an artificial intelligence circuit that receives from at least one sensor a characteristic signal and that transmits an indicator signal indicative of an item in a repository.

17. A method as claimed in claim 14, wherein the second control message configures an indicator circuit that receives from an artificial intelligence circuit an indicator signal and that indicates an item in a repository based on the indicator signal.

18. A method as claimed in claim 14, where learning by the repository system from the first control message includes teaming to use only the communication protocols and radio frequency characteristics of the first control message to communicate with the repository controller.
